(19) United States
(12) Patent Application Publication
(10) Pub. No.: US 2008/0049997 A1
(43) Pub. Date: Feb. 28, 2008

(54) Method and device for enhancing images in display devices

(76) Inventor: Daniel Chin, McCook, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/812,963

(22) Filed: Jun. 22, 2007

Related U.S. Application Data
(60) Provisional application No. 60/830,321, filed on Jul. 12, 2006.

(51) Int. Cl. G06K 9/00; G06K 9/40

(52) U.S. Cl. 382/128; 382/254

(57) ABSTRACT

An image enhancement system includes a data source providing image data of an object, an enhancement data storage including image enhancement information, an image enhancement unit configured to enhance the image data based on the image enhancement information, and a color display configured to display a monochrome image representing the enhanced image data on a screen thereof. The enhanced image data may include a gray level scale of at least 32 bits per pixel.

### CROSS REFERENCE TO PRIOR APPLICATIONS

This application claims priority to and the benefit of U.S. Provisional Application No. 60/830,321, entitled “VIDEO DISPLAY BRIGHTNESS CONTROL SYSTEM AND METHOD” filed on Jul. 12, 2006, which is hereby incorporated by reference for all purposes as if fully set forth herein.

### BACKGROUND OF THE INVENTION

1. Field of the Invention

The invention is directed to a device and method for enhancing monochrome images, and, in particular, enhancing monochrome images in color display devices.

2. Related Art

Many industrial/technical fields require displaying monochrome images as a part of testing, analysis, diagnosis and so on. Monochrome display devices such as monochrome LCD devices are still commonly used in these industrial/technical fields (e.g., medical, sensing and testing fields and the like) for displaying the monochrome images. For example, FIGS. 1-3 show monochrome images such as an X-ray, magnetic resonance imaging (MRI), and computerized axial tomography (CAT) scan images, respectively. Medical images require monochrome displays that are capable of providing a level of visual quality necessary for the medical professionals to properly and accurately review and analyze the images.

However, monochrome LCD panels are more expensive than color LCD devices. This is due in part because the demand for high quality monochrome LCD devices in the market is significantly lower than the demand for color LCD devices. Although color LCD panels can display monochrome images, the color LCD devices are typically inadequate to properly display technical monochrome images such as X-ray, MRI, CAT scan, ultrasound images or the like.

Additionally, it is estimated that about 80% of the users are either not in need of a high quality monochrome display device or fail to use the display device to its fullest capabilities even if provided with such a high quality monochrome device. For example, high quality monochrome LCD panels for technical applications are capable of displaying images at very high screen resolutions (e.g., 2 to 5 mega pixels). However, only a very limited number of industrial/technical fields require such high resolution for displaying monochrome images or are provided with the necessary equipment (e.g., image viewing software, graphic hardware, and the like) to fully utilize the high quality monochrome LCD panels.

Finally, since a monochrome display device cannot display color images, the users are unable to fully utilize other applications that are color-based. This requires the users to purchase another color display device or not fully utilize the color-based applications. Thus, for most industrial/technical fields, it is more costly to use monochrome LCD devices although they may benefit from the capabilities thereof.

Accordingly, there is a need for a lower cost solution for displaying high quality monochrome images that may also allow for displaying color images.

### SUMMARY OF THE INVENTION

The invention meets the foregoing need and other advantages apparent from the discussion herein by allowing a color display device, such as a color LCD device, to display high quality monochrome images.

According to one aspect of the invention, an image enhancement system includes a data source providing image data of an object, an enhancement data storage including image enhancement information, an image enhancement unit configured to enhance the image data based on the image enhancement information, and a color display configured to display a monochrome image representing the enhanced image data on a screen thereof. The enhanced image data includes a gray level scale of at least 32 bits per pixel.

According to another aspect of the invention, a method of enhancing an image includes selecting image data representing an image of an object, enhancing the image data using image enhancement information, and displaying a monochrome image representing the enhanced image data on a screen of a color display. The image enhancement information includes a gray level scale of at least 32 bits per pixel.

According to yet another aspect of the invention, a machine-readable medium storing instructions, which, when executed by at least one of a general-purpose processor, cause the general-purpose processor to enhance an image, the instructions includes instructions for selecting image data representing an image of an object, instructions for enhancing the image data using image enhancement information, which includes a gray level scale of at least 32 bits per pixel, and instructions for displaying a monochrome image representing the enhanced image data on a screen of a color display.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a monochrome X-ray image of a foot that may require a higher-quality monochrome display device;

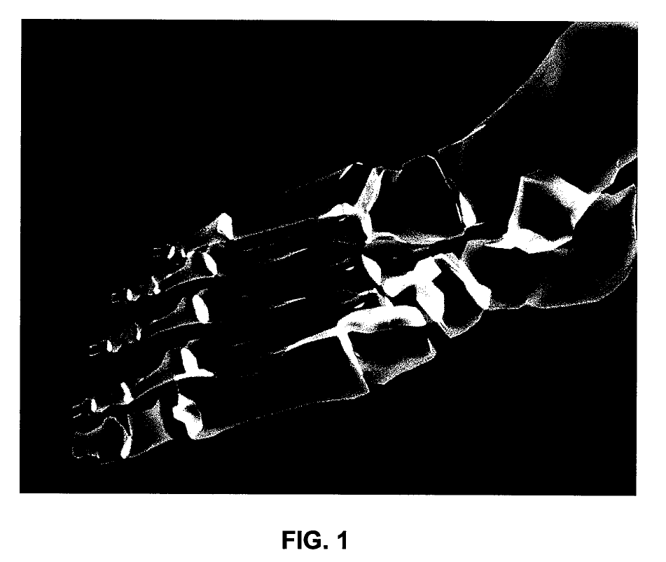

FIG. 2 shows a monochrome MRI image of a human head that may require a higher-quality monochrome display device;

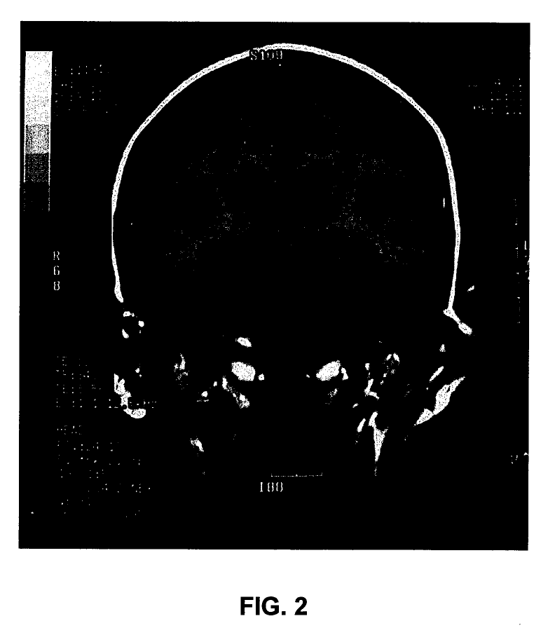

FIG. 3 shows monochrome CAT scan images of a brain that may require a higher-quality monochrome display device;

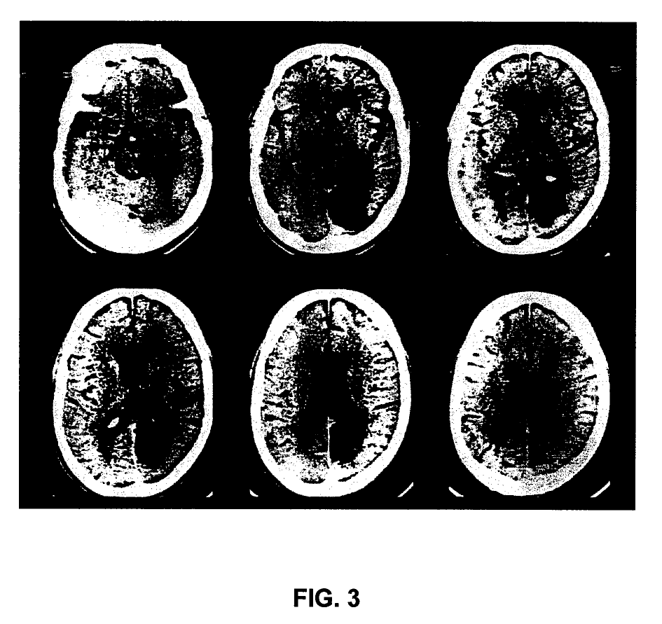

FIG. 4 shows a structural overview of a system for displaying an enhanced monochrome image using a color display device, constructed according to the principles of the invention;

FIG. 5 shows a flow chart for displaying an enhanced monochrome image using a color display device, constructed according to the principles of the invention; and

FIG. 6 shows a structural overview of a color LCD configured to display an enhanced monochrome image, constructed according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

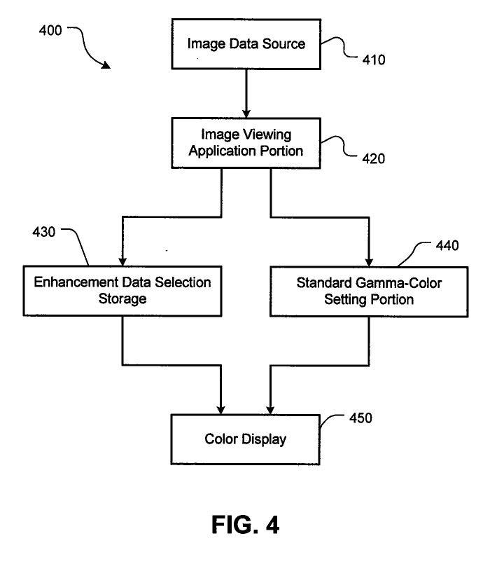

FIG. 4 shows a structural overview of a system 400 for displaying enhanced monochrome images using a color display device such as a color LCD panel. As shown therein, the system 400 may include an image data source 410, image viewing application portion 420, enhancement data selection storage 430, standard gamma-color setting portion 440 and a color display 450. The combination of these components in the system 400 may allow for the display of high-quality monochrome images using a lower cost color display device. Furthermore, the system 400 may also allow the user to display color images for other applications.

The image data source 410 may be an image capturing device, such as an X-ray, MRI, CAT scan, ultrasonic machine or the like, which may capture a visual image of an object obtained through one or more known sensors and transform the captured image to digital image data. The image data may be compressed using a variety of standards, including JPEG, JPEG Lossless, JPEG 2000, Run-length encoding (RLE), and so on. The data may be image data related to angioscopy, biomagnetic imaging, color flow doppler, cinefluorography, colposcopy, computed radiography, cystoscopy, computed tomography, duplex doppler, digital fluoroscopy, diaphanography, digital microscopy, digital subtraction angiography, digital radiography, echocardiography, endoscopy, fluorescein angiography, fundoscopy, laparoscopy, laser surface scan, magnetic resonance angiography, mammography, magnetic resonance, magnetic resonance spectroscopy, nuclear medicine, positron emission tomography (PET), radio fluoroscopy, radiographic imaging (conventional film screen), radiotherapy dose, radiotherapy image, radiotherapy plan, radiotherapy structure set, single-photon emission computed tomography, thermography, ultrasound, videofluorography, x-ray angiography, electrocardiograms, and so on.

Alternatively, the image data source 410 may be a data storage which stores digital image data from the image capturing device. The data storage may be a picture archiving and communication system (PACS), which may be computers or networks dedicated to the storage, retrieval, distribution and presentation of images. A full PACS system may provide a single point of access for images and their associated data (i.e., it should support multiple modalities). It may also interface with existing hospital information systems: hospital information system (HIS) and radiology information system (RIS). For medial applications, the images may be compliant with DICOM (Digital Imaging and Communications in Medicine) standard, which has been widely adopted by hospitals and doctors' offices to enable the integration of scanners, servers, workstations, printers, and network hardware from multiple manufacturers into an image archiving and communication system.

The monochrome image data in the image data source 410 may be of a very high resolution (e.g., 2 to 5 mega pixels) and may require a monochrome display to properly display the details for accurate analysis and/or diagnosis. The high-quality monochrome image data may not be properly displayed on the color display 450 without other components of the system 400 because the color display 450 is calibrated to primarily display color images at a relatively low resolution (e.g., less than 2 mega pixels).

The user may access, open, manipulate, and so on the image data using the image viewing application portion 420 to display an image representing the image data on the color display 450. For medical applications, the image viewing application portion 420 may be DICOM compatible. For example, the image viewing application portion 420 may be Medview™ by ViewTec AG, Switzerland, or the like. The image viewing application portion 420 may allow displaying both monochrome and color images. Alternatively, the image viewing application portion 420 may be specifically configured to display high resolution monochrome images on the color display 450 such as an X-ray viewer program specifically designed for monochrome X-ray images as described in detail below.

The image viewing application portion 420 may be functionally connected directly or indirectly to the enhancement data selection storage 430 and standard gamma-color setting portion 440. The enhancement data selection storage 430 may include image enhancement information that may be used for enhancing the image data from the image data source 410 such that a high resolution monochrome image may be properly displayed on the color display 450. For example, the enhancement data selection storage 430 may include a gray scale level look-up table (LUT) to improve the contrast of the monochrome image. The LUT may be replaced or used in conjunction with a color look-up table (CLUT), colormap, palette, pseudocolor palette, and so on, to determine the colors and intensity values with which a particular gray scale image will be displayed. The above may be used in combination with a small amount of computation, often using interpolation. This may allow better accuracy for values falling between two pre-computed values. The monochrome image data may be stored with a low gray level scale (e.g., 256 gray levels, 8 bits per sampled pixel) which may be sufficient to avoid visible banding artifacts. According to the invention and, particularly for technical applications (e.g., medical imaging or the like), the image data may be adjusted using 32 bits or higher gray level scale (e.g., 64 bits) for enhancing the contrast of the monochrome images. In addition to the high gray level LUT, the image enhancement information may include other enhancement values such as brightness, sharpness, gamma and the like. In the case that no enhancement is required, for example, displaying images for non-technical applications, the image may be processed by the standard gamma-color setting portion 440.

The monochrome image data enhanced by the enhancement data selection storage 430 may be displayed on the color display 450 with significantly improved contrast using, for example, the 32 bits gray level scale (i.e., 4294967296 gray levels) or higher (e.g., 64 bits gray level scale), thereby enabling the color display 450 to display high contrast monochrome images. Also, other enhancements such as one or more of refresh rate, contrast adjustment, sharpness, brightness, gamma luminance, YUV, automatic gain and the like may be performed on the image if necessary. For example, any one or more of the following graphics techniques may be used for improving image quality: Anti-aliasing (a technique used to counter distortion caused by aliasing effects); Shader (pixel and vertex processing in terms of illumination, atmospheric optical phenomena or multi-layer surfaces); High dynamic range rendering (a technique used to enable a wider range of brightness in real scenes (from light sources to dark shadows); Texture mapping (allows the addition of details on surfaces, without adding complexity); Motion blur (technique that blurs objects in motion); Depth of field (technique that blurs faraway objects); Lens flare (imitation of light sources); Fresnel effect (reflections over an object, depending on the angle of vision. The more angle of vision, the more reflection); and Anisotropic filtering (enhances viewing angle of a displayed texture as it increases).

Furthermore, the enhancement data selection storage 430 may include instructions for adjusting the screen resolution such that the enhanced image may be displayed on the screen at a higher or optimum resolution. For example, the enhancement data selection storage 430 may control a graphic controller (not shown) to switch from a low screen resolution setup (e.g., SVGA (800×600), XGA (1024×768) or SXGA (1280×1024) to a high screen resolution (e.g., UXGA (1600×1200), QXGA (2048×1536) or HXGA (4096×3072)) to display the details of the enhanced image.

The color display 450 of the invention may be any known display technology including LCD, plasma, CRT, and so on. Moreover, the invention contemplates future enhancements and future display technologies may be used with the invention.

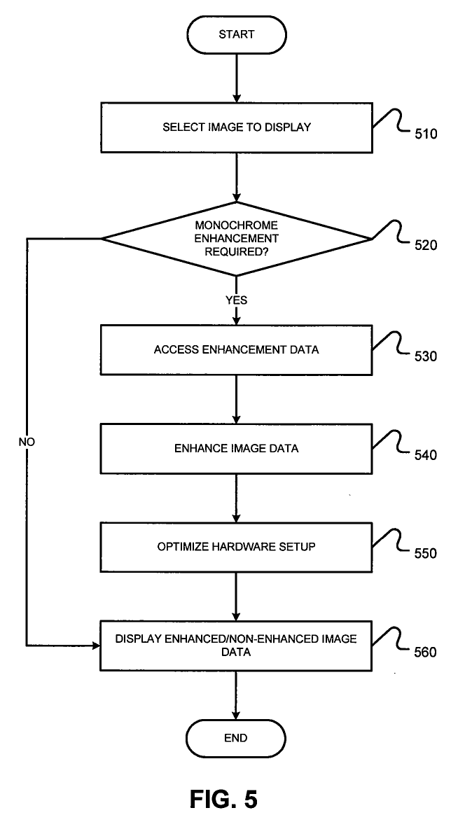

FIG. 5 shows a flow chart for displaying an enhanced monochrome image using a color display, constructed according to the principles of the invention. The process steps shown in FIG. 5 may be performed using the system 400 shown in FIG. 4. At step 510, an image may be selected by a user for viewing on the color display 450. As mentioned above, the system 400 may be configured to display both color and monochrome images, and the monochrome images may be technical (e.g., medical, testing, sensing images, and so on).

At step 520, it may be necessary to determine whether it is necessary to enhance the selected image or not. The system 400 may automatically determine that the selected image requires enhancement based on analysis of the selected image or through certain user interaction. For example, a technical monochrome image may have a unique extension which may trigger the system 400 to perform the predetermined enhancement operation. Alternatively, the user may determine whether the selected image requires enhancement or not, using, for example, the image viewing application 420. For example, the user may select either 32 or 64 bits gray scale level adjustment on the selected image using the image viewing application portion 420. Furthermore, the image viewing application portion 420 may allow the user to manipulate the selected image. For example, the image viewing application portion 420 may allow the user to move, resize or rotate the selected image while monitoring the image displayed on the color display 450.

At step 530, upon determining to enhance the selected image, information required for the enhancement may be obtained. As mentioned above, the enhancement data selection storage 430 may contain image enhancement information, which may be used for the enhancement operation to display high-quality monochrome images. At step 540, upon acquiring the image enhancement information, the selected image may be enhanced to display the selected image on the color display 450.

In addition to enhancing the image, the hardware setup of the system 400 may be optimized at step 550. For example, the color display 450 may switch from a low screen resolution setup (e.g., SXGA (1280×1024), XGA (1024×768) or SVGA (800×600)) to a high screen resolution (e.g., UXGA (1600×1200), QXGA (2048×1536) or HXGA (4096×3072)) to display the details of the enhanced image. Also, other display options such as a refresh rate, contrast adjustment, sharpness, brightness, gamma, luminance, YUV, automatic gain, or the like, may be optimized. Upon completing the image enhancement and/or hardware optimization, at step 560, the selected image may be displayed on the color display 450 at a quality satisfactory for the use.

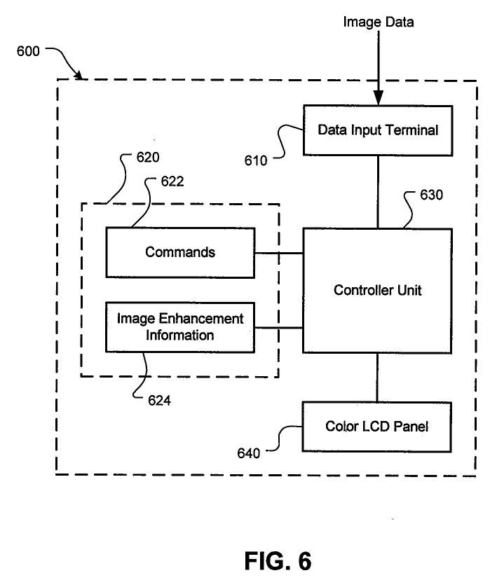

A further embodiment of the invention for displaying enhanced monochrome images using a color display device may use a different configuration and method shown than FIGS. 4 and 5. For example, the system 400 shown in FIG. 4 may be modified to be implemented internally to a color display device such as a color LCD monitor 600 shown in FIG. 6. More specifically, the color LCD monitor 600 may be provided with firmware 620 programmed for enhancing image data received via a data input terminal 610. The firmware 620 may contain image enhancement data 624 and a series of commands 622, which may be executed by a controller unit 630 to enhance the image data. The firmware 620 may be stored in an internal storage of the monitor 600 (e.g., on-board EPROM or the like) or embedded internally in the controller unit 630. Upon receiving the image data from the data input terminal 610, the controller unit 630 may obtain the commands 622 and image enhancement information 624 and execute the commands to enhance the image data based on image enhancement information 624. The enhanced image data may be sent to a color LCD panel 640, which may display an image on a screen thereof based on the enhanced image data from the controller unit 630. The firmware 620 may also be programmed to provide an on-screen display (OSD) menu which may allow the users to control the enhancement operations. For example, the OSD menu may allow the users to select a predetermined setting for displaying an enhanced monochrome image on the screen.

Accordingly, the invention enables a lower cost color display to properly display images with very high quality. Since both color and monochrome images may be displayed, the invention eliminates the need to acquire a higher cost monochrome display solely for monochrome images, thereby increasing user ability and reducing operational costs. Furthermore, the invention may be implemented to the existing systems (e.g. personal computers) without excessive modification by simply adding the image enhancement data thereto.

In accordance with various embodiments of the invention, the methods described herein are intended for operation with dedicated hardware implementations including, but not limited to, semiconductors, application specific integrated circuits, programmable logic arrays, and other hardware devices constructed to implement the methods and modules described herein. Moreover, various embodiments of the invention described herein are intended for operation as software programs running on a computer processor. Furthermore, alternative software implementations including, but not limited to, distributed processing, component/object distributed processing, parallel processing, virtual machine processing, any future enhancements, or any future protocol can also be used to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. An image enhancement system, comprising:
a data source providing image data of an object;
an enhancement data storage including image enhancement information;
an image enhancement unit configured to enhance the image data based on the image enhancement information; and
a color display configured to display a monochrome image representing the enhanced image data on a screen thereof,
wherein the enhanced image data includes a gray level scale of at least 32 bits per pixel.

2. The image enhancing system of claim 1, wherein the color display is an LCD device.

3. The image enhancement system of claim 1, wherein the monochrome image is at least one of an X-ray, MRI, CAT scan and ultrasonic image.

4. The image enhancement system of claim 1, wherein the enhanced image data is compliant with DICOM (Digital Imaging and Communications in Medicine) standard.

5. The image enhancement system of claim 1, wherein the data source comprises a data capturing device configured to generate an image of the object and convert the captured image to the image data.

6. The image enhancement system of claim 5, wherein the data source further comprises a picture archiving and communication system configured to receive and store the image data.

7. The image enhancement system of claim 1, wherein the image enhancement unit comprises a graphic controller configured to drive the color display.

8. The image enhancement system of claim 7, wherein the graphic controller is configured to increase a screen resolution of the display unit.

9. The image enhancement system of claim 7, wherein the image enhancement unit further comprises an image viewing application functionally connected to the enhancement data storage and the graphic controller.

10. The image enhancement system of claim 1, wherein the image enhancement unit is configured to enhance at least one of contrast, brightness, sharpness, luminance, YUV, automatic gain, and gamma values of the image data.

11. A method of enhancing an image, comprising the steps of:
selecting image data representing an image of an object;
enhancing the image data using image enhancement information; and
displaying a monochrome image representing the enhanced image data on a screen of a color display,
wherein said image enhancement information includes a gray level scale of at least 32 bits per pixel.

12. The method of claim 11, further comprising optimizing a hardware setup.

13. The method of claim 12, wherein the optimizing step comprises increasing a screen resolution of the color display.

14. The method of claim 11, wherein the enhancing step includes enhancing at least one of contrast, brightness, sharpness, luminance, YUV, and gamma values of the image data.

15. The method of claim 11, further comprising determining whether the selected image data requires enhancement.

16. The method of claim 11, wherein the enhanced image data is compliant with DICOM (Digital Imaging and Communications in Medicine) standard.

17. The method of claim 11, further comprising the steps of:
generating the image of the object; and
storing the captured image.

18. The method of claim 11, wherein the monochrome image is at least one of an X-ray, MRI, CAT scan and ultrasonic image.

19. The method of claim 11, wherein the color display is an LCD device.

20. A machine-readable medium comprising instructions, which, when executed by at least one of a general-purpose processor, cause the general-purpose processor to enhance an image, the instructions comprising:
instructions for selecting image data representing an image of an object;
instructions for enhancing the image data using image enhancement information, said image enhancement information including a gray level scale of at least 32 bits per pixel; and
instructions for displaying a monochrome image representing the enhanced image data on a screen of a color display.

21. The machine-readable medium of claim 20, further comprising instructions for determining whether the selected image data requires enhancement.

22. The machine-readable medium of claim 20, further comprising instructions for optimizing a hardware setup.

23. The machine-readable medium of claim 22, wherein the instructions for optimizing the hardware setup comprises instructions for increasing a screen resolution.

24. A color LCD device, comprising:
a data input terminal configured to receive monochrome image data of an object;
an internal data storage containing image enhancement data;
a controller unit configured to execute a series of commends for enhancing the monochrome image data based on the image enhancement data;
a color LCD panel configured to display a monochrome image on a screen thereof based on the enhanced monochrome image data,
wherein the enhanced monochrome image data includes a gray level scale of at least 32 bits per pixel.

25. The color LCD device of claim 24, comprising a color LCD monitor.

26. The color LCD device of claim 24, wherein the internal data storage is internal to the controller unit.

27. The color LCD device of claim 24, wherein the series of commands are stored in the internal data storage.

28. The color LCD device of claim 24, further comprising an on-screen display menu for allowing a user to select a predetermined display setting for displaying an enhanced monochrome image on the screen.
